(19) United States
(12) Patent Application Publication
(10) Pub. No.: US 2020/0242558 A1
(43) Pub. Date: Jul. 30, 2020

(54) METHOD AND APPARATUS FOR DECOMMISSIONING PLAN OF NUCLEAR FACILITY

(71) Applicant: Korea Atomic Energy Research Institute, Daejeon (KR)

(72) Inventors: KwanSeong JEONG, Sejong-si (KR); Seung-Kook PARK, Daejeon (KR); Inhye HAHM, Gangwon-do (KR); Jea Hyun HA, Daejeon (KR); SuJung MIN, Seoul (KR); Sang Bum HONG, Daejeon (KR); Bum Kyoung SEO, Daejeon (KR)

(21) Appl. No.: 16/744,681

(22) Filed: Jan. 16, 2020

(30) Foreign Application Priority Data
Jan. 28, 2019 (KR) 10-2019-0010608

(51) Int. Cl. G06Q 10/10; G06Q 50/26

(52) U.S. Cl. CPC G06Q 10/103; G06Q 50/26

(57) ABSTRACT

There is provided a method for decommissioning plan of nuclear facility includes receiving a plurality of decommissioning related information data, and determining whether error data is included in the plurality of decommissioning related information data based on a database which contains characteristic information and decommissioning plan information of a plurality of nuclear facilities. The method further includes analyzing a state of a decommissioning target facility by identifying the decommissioning target facility based on the plurality of decommissioning related information data and the database, wherein when the error data is included in the plurality of decommissioning related information data, said analyzing is performed by identifying the decommissioning target facility based on the plurality of decommissioning related information data from which the error data is excluded and the database. The method further includes designing a decommissioning plan of the decommissioning target facility based on the analyzed state.

### CROSS-REFERENCE TO RELATED APPLICATION

This application is based on and claims priority from Korean Patent Application No. 10-2019-0010608, filed on Jan. 28, 2019, the disclosure of which is incorporated herein in its entirety by reference for all purposes.

### FIELD OF THE INVENTION

The present disclosure relates to a method and an apparatus for decommissioning plan of a nuclear facility.

### BACKGROUND OF THE INVENTION

The deterioration of nuclear facilities results in increasing the number of decommissioning of the nuclear facilities worldwide. Accordingly, there has been a growing interest in decommissioning technologies for the nuclear facilities in consideration of various safety assessments including the possibility of radiation exposure.

Specifically, when decommissioning the nuclear facility, a decommissioning plan containing the direction and details of decommissioning of the nuclear facility should be submitted under the Nuclear Safety Act. On the other hand, since a lot of information should be considered when decommissioning of the nuclear facility requires, the process of plaining the decommissioning and drawing up the decommissioning plan is very complicated and faces many difficulties (see, e.g., Korean Patent Laid-open Publication No. 10-2013-0022033 (Published on Mar. 6, 2013)).

Currently, in the decommissioning plan of the nuclear facility, several persons in charge of decommission have designed the decommissioning plan, taking account of various regulations and characteristics of the nuclear facility. In such a case, errors may occur due to human manual work, and a lot of information should be considered so that it actually takes a lot of time to complete the decommissioning plan. Therefore, there is required a technique for more quickly and easily completing the decommissioning plan of the nuclear facility.

### SUMMARY OF THE INVENTION

It is an object of the present disclosure to provide a method and an apparatus for decommissioning plan of a nuclear facility by designing decommissioning prior to decommissioning the nuclear facility, and identifying and verifying whether the content of the designed decommissioning is suitable for the nuclear facility to be decommissioned.

However, the object to be solved by the present disclosure is not limited to the above-mentioned, and includes the purpose that can be clearly understood by those skilled in the art from the following description, although not described herein.

In accordance with a first aspect of the present disclosure, there is provided A method for decommissioning plan of nuclear facility, including: receiving a plurality of decommissioning related information data; determining whether error data is included in the plurality of decommissioning related information data based on a database which contains characteristic information and decommissioning plan information of a plurality of nuclear facilities; analyzing a state of a decommissioning target facility by identifying the decommissioning target facility based on the plurality of decommissioning related information data and the database, wherein when the error data is included in the plurality of decommissioning related information data, said analyzing is performed by identifying the decommissioning target facility based on the decommissioning related information data from which the error data is excluded and the database; and designing a decommissioning plan of the decommissioning target facility based on the analyzed state.

In accordance with a second aspect of the present disclosure, there is provided an apparatus for decommissioning plan of nuclear facility, including: a data receiver for receiving a plurality of decommissioning related information data; a discriminating unit for determining whether error data is included in the plurality of decommissioning related information data based on a database which contains characteristic information and decommissioning plan information of a plurality of nuclear facilities; an analyzing unit for analyzing a state of a decommissioning target facility by identifying the decommissioning target facility based on the plurality of decommissioning related information data and the database, wherein when the error data is included in the plurality of decommissioning related information data, the analyzing unit analyzes the state of the decommissioning target facility by determining the decommissioning target facility based on the plurality of decommissioning related information data from which the error data is excluded and the database; and a designing unit for designing a decommissioning plan of the decommissioning target facility based on the analyzed state.

The method and apparatus for decommissioning plan of the nuclear facility according to the aspects of the present disclosure ensures the reliability and safety of the decommissioning plan by designing decommissioning of the nuclear facility, and identifying and verifying whether the content of the designed decommissioning is suitable for the nuclear facility to be decommissioned.

The effects obtained by the present disclosure are not limited to those mentioned above, and another effects not mentioned above may be clearly understood by those skilled in the art from the following description.

### BRIEF DESCRIPTION OF THE DRAWINGS

The objects and features of the present disclosure will become apparent from the following description of embodiments, given in conjunction with the accompanying drawings, in which:

FIG. 1 shows an example of the functional configuration of an apparatus for decommissioning plan of a nuclear facility according to a first aspct of the present disclosure;

FIG. 2 a flow chart showing steps of a method for decommissioning plan of the nuclear facility according to a second aspect of the present disclosure;

FIG. 3 conceptually illustrates an example of a database used in performing the method for decommissioning plan of the nuclear facility according to the second aspect of the present disclosure; and

FIG. 4 conceptually illustrates a process of analyzing a state of a target facility to be decommissioned by the apparatus for decommissioning plan of the nuclear facility according to the first aspect of the present disclosure.

### DETAILED DESCRIPTION OF THE EMBODIMENTS

Hereinafter, configurations and operations of embodiments will be described in detail with reference to the accompanying drawings. The following description is one of various patentable aspects of the disclosure and may form a part of the detailed description of the disclosure.

In describing the embodiments of the present disclosure, the detailed descriptions of well-known functions or configurations will be omitted if it is determined that the detailed descriptions of well-known functions or configurations may unnecessarily make obscure the spirit of the present disclosure.

The disclosure may be variously modified and may include various embodiments. Specific embodiments will be exemplarily illustrated in the drawings and described in the detailed description of the embodiments. However, it should be understood that they are not intended to limit the disclosure to specific embodiments but rather to cover all modifications, similarities, and alternatives which are included in the spirit and scope of the disclosure.

The terms used herein, including ordinal numbers such as “first” and “second” may be used to describe, and not to limit, various components. The terms simply distinguish the components from one another.

When it is said that a component is “coupled” or “linked” to another component, it should be understood that the former component may be directly connected or linked to the latter component or a third component may be interposed between the two components.

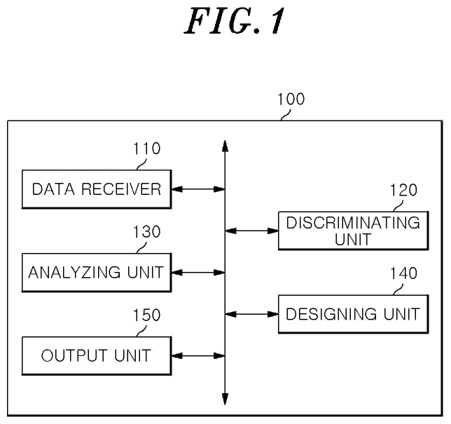

FIG. 1 shows an example of the functional configuration of an apparatus for decommissioning plan of a nuclear facility according to an embodiment of the present disclosure. The term ‘ . . . unit’ used below refers to a unit of processing at least one function or operation, which may be implemented by a hardware or a software, or a combination of the hardware and the software.

Referring to FIG. 1, the apparatus for decommissioning plan of the nuclear facility may include a data receiver 110, a discriminating unit 120, an analyzing unit 130, a designing unit 140, and an output unit 150.

The data receiver 110 may receive a plurality of decommissioning related information data. The decommissioning related information may include, for example, at least one of information on the structure or equipment included in the nuclear facility to be decommissioned (hereinafter, referred to as a decommissioning target facility), information on a history of design, construction and heat output of the nuclear facility, information on a weight, a size, an installation location, and used materials of the equipment installed in the decommissioning target facility, information on a design change of the decommissioning target facility, and information on a history of an accident, a cause of the accident, and an action for the accident in the decommissioning target facility.

The discriminating unit 120 may determine whether error data is included in the received decommissioning related information data based on a database which contains characteristic information and decommissioning plan information of a plurality of nuclear facilities. The error data may refer to wrong data that is not relevant to the decommissioning target facility.

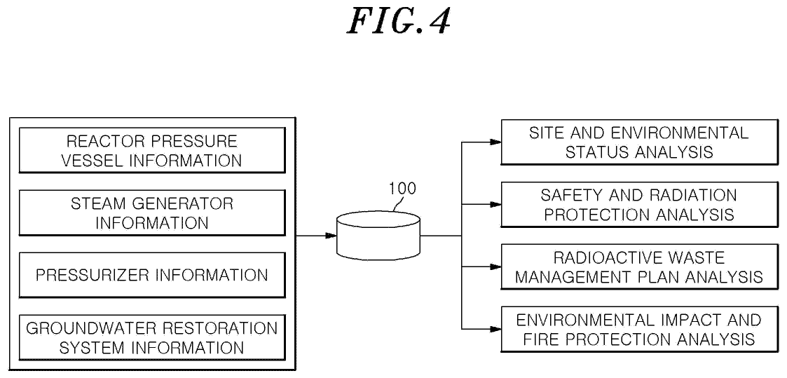

The discriminating unit 120 may analyze the relationship between the data and extract the error data based on the analysis when it receives a plurality of data. The discriminating unit 120 may extract the error data by determining whether the plurality of received data forms a linking structure. For example, the discriminating unit 120 may link related data to each other for the same decommissioning target facility based on the information including the relevance of the structure or equipment installed in the decommissioning target facility to form the linking structure. In such a case, if the error data, which is data for other nuclear facilities, is received, it may exist independently without being linked. The discriminating unit 120 may determine the data which exist independently without being linked with other data as the error data. FIG. 4 shows an example related to the error data.

The discriminating unit 120 may use information previously stored in a database, for example, information on the structure and equipment that can be installed for each type of the nuclear facilities, so as to form the linking structure.

When the error data is included, the analyzing unit 130 may identify a decommissioning target facility based on a database and remaining data except the error data among the plurality of data, and analyze a state of the decommissioning target facility. The analyzing unit 130 may determine a decommissioning technique to be used for decommissioning the decommissioning target facility, based on the database and the state analysis result of the decommissioning target facility.

In this case, the database may include a variety of information about the nuclear facilities, and, for example, may include decommissioning plan information of the nuclear facility. The decommissioning plan information may include decommissioning technique information available for each type of the nuclear facilities and information on laws and regulations for a nuclear facility.

The designing unit 140 may design decommissioning (or decommissioning plan) such that the analyzed state and the determined decommissioning technology are to be represented in a hierarchical structure according to a decommissioning order, a priority relationship or an inclusion relationship, based on the database, the type of the decommissioning target facility, and information on the structure and equipment of the decommissioning target facility. Herein, “designing a decommissioning plan” may mean designing a decommissioning plan in a form of a hierarchical structure for drawing up the decommissioning plan using the state of the decommissioning target facility and the available decommissioning technology derived by the analyzing unit 130.

In detail, the designing unit 140 may design the decommissioning plan based on the determination result whether information on the state of the decommissioning target facility and the available decommissioning technology form the hierarchical structure. For example, when the information does not represented in the form of the hierarchical structure, the designing unit 140 may make the information on the state of the decommissioning target facility and the decommissioning technology represented in the hierarchical structure, based on the decommissioning order, the priority relationship or the inclusion relationship. On the other hand, the information about the decommissioning order, the priority relationship, and the inclusion relationship may be pre-stored in the database.

When represented in the hierarchical structure, the designing unit 140 may determines whether the decommissioning technology and the analyzed state are properly configured in the hierarchical structure based on the information on the decommissioning order, the priority relationship or the inclusion relationship. If they are properly configured in the hierarchical structure, the decommissioning design can be completed, and otherwise, the related part can be modified to represent the decommissioning design in the hierarchical structure.

The information about the completed decommissioning design may be output to a user through the output unit 150 in the form of a decommissioning plan. The form in which the information is provided to the user may include, but is not limited to, visual information or audio information.

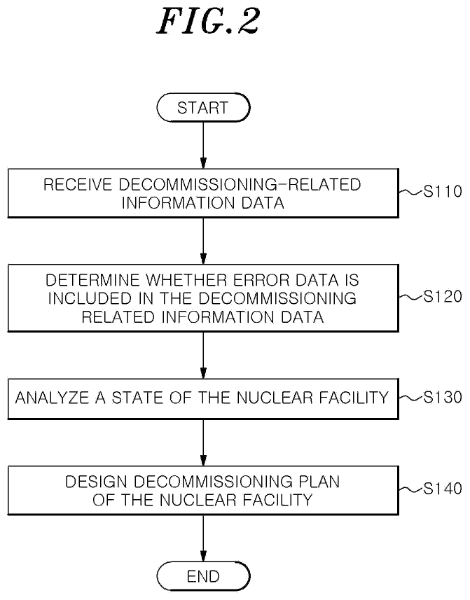

FIG. 2 shows the flow of each step of a method for decommissioning plan of a nuclear facility according to the embodiment of the present disclosure. Each step of the method shown in FIG. 2 will be described using each configuration of FIG. 1. Hereinafter, the content duplicated with the content described in FIG. 1 will be omitted.

Referring to FIG. 2, the data receiver 110 may receive a plurality of decommissioning related information data (step S110). The decommissioning related information may include at least one of information on the structure or equipment included in the decommissioning target facility to be decommissioned, information on a history of design, construction and heat output of the nuclear facility, information on a weight, a size, an installation location, and used materials of the equipment installed in the nuclear facility, information on a design change of the nuclear facility, and information on a history of an accident, a cause of the accident, and an action for the accident in the nuclear facility. However, this information is merely an example, and the data receiver 110 may receive data on various information related to the decommissioning of the nuclear facility without being limited to the above-described aspects.

The discriminating unit 120 may determine whether error data is included in a plurality of decommissioning related information data based on a database which contains characteristic information and decommissioning plan information of a plurality of nuclear facilities (step S120). Specifically, the discriminating unit 120 may determine that the error date is included when there is data that is not linked to a linking structure which defines connection relationship between the respective received data based on the characteristic information of the nuclear facilities. In this case, the error data may be data that is not linked.

On the other hand, the characteristic information for the plurality of nuclear facilities may include, for example, various information on the structure and equipment that can be included in each of the plurality of nuclear facilities according to each type of the plurality of nuclear facilities, and information on the relationship between these information (e.g., inclusion relationship, priority relationship). The decommissioning plan information may include, for example, decommissioning technique information available for each type of the plurality of nuclear facilities and information on laws and regulations related to the plurality of nuclear facilities. The decommissioning technique information may include at least one of radiation measurement technique, decontamination technique, cutting technique, waste treatment techniques, and site restoration technique.

When the error data is included, the analyzing unit 130 may identify a decommissioning target facility to be decommissioned, based on a database and remaining data except the error data among the plurality of data, analyze a state of the decommissioning target facility, and determine a decommissioning technique to be used for decommissioning (step S130). For example, the analyzing unit 130 may determine the decommissioning technique to be used in consideration of each characteristic of the structure and equipment of the decommissioning target facility (e.g., materials or installation location).

Specifically, the analyzing unit 130 may carry out analysis of at least one of decommissioning site and environmental status of the decommissioning target facility, decommissioning work activity, comparison of the applicable decommissioning technique, radioactive waste management, environmental impact during decommissioning, safety of decommissioning, radiation protection, fire protection, and decommissioning cost.

With respect to the analysis of the decommissioning site and the environmental status of the decommissioning target facility, the analyzing unit 130 may analyze a type of radioactive material, an amount of radioactivity, and a degree of radioactive contamination which is present in structure and equipment of the decommissioning target facility.

With respect to the analysis of the decommissioning work activity, the analyzing unit 130 may analyze a method and procedure of the decontamination technique or the cutting technique applied to the decommissioning work, and the structure and equipment contaminated with radioactive material among the structures included in the decommissioning target facility, or a method and procedure of the technique applicable to restoration of soil, surface water and groundwater contaminated with the radioactive material

With respect to the comparative analysis of the applicable decommissioning technique, the analyzing unit 130 may calculate at least one of a maximum working time, a minimum working time, a maximum exposure dose, a minimum exposure dose, an amount of a maximum radioactive waste, and an amount of a minimum radioactive waste, which are expected based on the structure and equipment of the decommissioning target facility for each of the technologies applied to the decommissioning work activity, and analyze a difference between the calculated results.

With respect to the analysis of the radioactive waste management, the analyzing unit 130 may determine a type, a volume, and an amount of the radioactive waste to be generated in the decommissioning operation, and analyze a method of treating, storing and disposing the radioactive waste in a solid state. This analysis may be performed by distinguishing whether the radioactive waste is a solid, a liquid or a gas. In addition, the analyzing unit 130 may determine a type, a volume, and an amount of mixed wastes to be generated in the decommissioning operation, and analyze a method of treating, storing and disposing the mixed waste.

With respect to the analysis of the environmental impact during decommissioning, the analyzing unit 130 may represent a measurement location, a measurement cycle, and a measurement method of the environmental impact of the decommissioning site, and analyze minimum and maximum values of individual exposure dose to which an individual will receive by radioactive effluents generated during the decommissioning process.

With respect to the safety analysis of decommissioning, the analyzing unit 130 may analyze residual radioactivity expected to exist in the facility and the site after the decommissioning completion, or types and locations of industrial safety risk factors such as fall hazard, electric shock hazard and choking hazard of a worker during the decommissioning operation.

With respect to the analysis of the radiation protection, the analyzing unit 130 may analyze a source term, a model, an assumption and input data used to calculate a minimum exposure dose, a maximum exposure dose, and an exposure dose that a worker will receive during the decommissioning process.

With respect to the analysis of the fire protection, the analyzing unit 130 may analyze a location where a fire can occur, a structure and equipment where the fire can occur, based on the technology applied to the structure and equipment constituting the decommissioning target facility.

With respect to the analysis of the decommissioning cost, the analyzing unit 130 may analyze costs based on a structure, a system, a device and the like of the decommissioning target facility and the technology applied to the decommissioning operation. The costs may include at least one of decommissioning costs of radioactive waste/non-radioactive waste, decommissioning costs of the structure and the equipment, and individual technology costs to be applied to the decommissioning operation.

The above specific items analyzed by the analyzing unit 130 of the decommissioning target facility are merely described as an example, and the spirit of the present disclosure is not limited thereto.

The designing unit 140 may design decommissioning of the decommissioning target facility based on the analyzed state (step S140). The designing unit 140 may design decommissioning such that a decommissioning plan is represented in a hierarchical structure based on a database which contains characteristic information and decommissioning plan information of the decommissioning target facility, and information about a type of the decommissioning target facility and a structure and equipment of the decommissioning target facility.

More specifically, the designing unit 140 may determine whether the decommissioning technique and the state of the decommissioning target facility determined by the analyzing unit 130 is represented in the hierarchical structure. If the decommissioning technique and the analyzed state are not represented in the hierarchical structure, the designing unit 140 may form information such that the decommissioning technique and the analyzed state are represented in the hierarchical structure based on information about a priority relationship or an inclusion relationship.

If the determined decommissioning technique and analyzed state are represented in the hierarchical structure, the designing unit 140 may determines whether the decommissioning technology and the analyzed state are properly configured in the hierarchical structure based on the information on the priority relationship or the inclusion relationship. If they are properly configured in the hierarchical structure, the decommissioning plan can be completed, and otherwise, the related part can be modified to represent the decommissioning plan in the hierarchical structure.

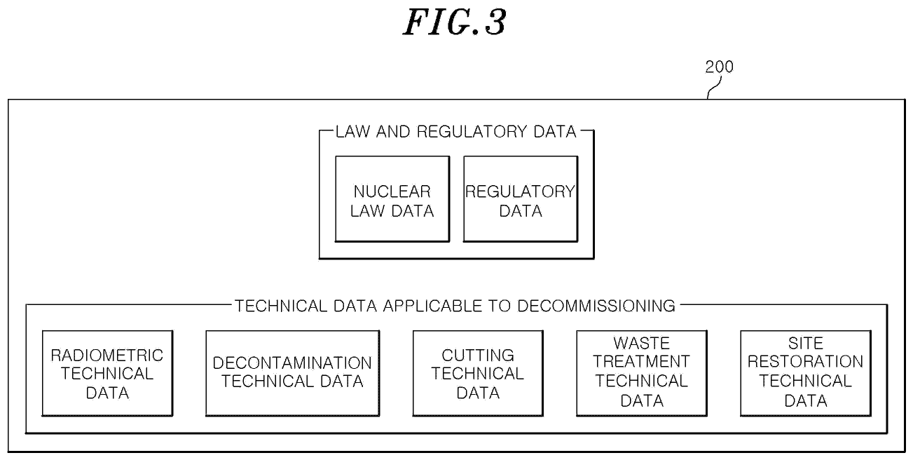

FIG. 3 conceptually illustrates an example of a database used by a method for decommissioning plan of a nuclear facility according to the embodiment of the present disclosure. The database shown in FIG. 3 may be included in the apparatus 100 for decommissioning plan of FIG. 1, or may be linked to the apparatus 100 for decommissioning plan by wire or without wire.

Referring to FIG. 3, the database 200 may include legal and regulatory data, and technical data applicable to decommissioning. In this case, the technical data applicable to decommissioning may be divided by an individual type of the nuclear facilities.

The legal and regulatory data may include nuclear law data and regulatory data. Specifically, the legal and regulatory data may include, e.g., data on domestic and foreign nuclear safety laws, nuclear safety enforcement decrees, nuclear safety enforcement regulations, nuclear safety committee notices, regulatory standards and regulatory guidelines, which are related to decommissioning of the nuclear facilities.

The technical data applicable to decommissioning may include radiometric technical data, decontamination technical data, cutting technical data, waste treatment technical data and site restoration technical data. Further, it may also include performance and physical property data for each technical data, site-specific impact and property data, radiological environmental impact data, schedule data and cost data.

Although not shown, the database 200 may include information on the decommissioning process of other nuclear facilities in the past, for example, types, characteristics, costs, used techniques, accident history data, and decommissioning procedures of the nuclear facilities that have been decommissioned in the past.

In addition, various pieces of information stored in the database 200 may be classified by types of the nuclear facilities.

Meanwhile, the examples included in the database 200 are not limited to those shown in FIG. 3, and the database 200 may include various information related to the nuclear facilities.

FIG. 4 conceptually illustrates a process of analyzing a state of a decommissioning target facility by the apparatus for decommissioning plan of the nuclear facility according to the embodiment of the present disclosure.

Referring to FIG. 4, the apparatus 100 for decommissioning plan may receive decommissioning related information. In this case, the decommissioning related information may include error data in addition to the information on the decommissioning target facility. For example, in case the decommissioning target facility is a nuclear reactor facility, information about a groundwater restoration device, which is an unrelated facility, may be input in addition to information on a pressure vessel, a steam generator and a pressurizer installed in the nuclear reactor facility.

In this case, the apparatus 100 for decommissioning plan may determine related information based on the database 200 and analyze the decommissioning target facility using the related information.

As shown in FIG. 4, the apparatus 100 of decommissioning plan may perform, e.g., at least one of site and environmental status analysis, safety and radiation protection analysis, radioactive waste management plan analysis, environmental impact and fire protection analysis, and derive the results thereon. However, the analysis performed by the apparatus 100 for decommissioning plan is not limited to those illustrated above and various analysis related to decommissioning of the decommissioning target facility may be additionally performed.

The apparatus 100 for decommissioning plan according to a first aspect of the present disclosure can provide the decommissioning plan having a higher reliability and an improved accuracy by analyzing the data on the decommissioning plan of the nuclear facility and removing a wrong data to perform the decommissioning plan.

In addition, the apparatus 100 for decommissioning plan according to the first aspect of the present disclosure allows a user to automatically generate a decommissioning plan based on various input information, so that the decommissioning plan can be made more quickly and easily. Further, the final decommissioning plan by the apparatus 100 for decommissioning plan may be represented in the form of a hierarchical structure to allow the user to more easily grasp a complicated decommissioning plan.

Furthermore, a computer-readable recording medium which stores a computer program according to a second aspect of the present disclosure may include instructions for causing a processor to perform a method for decommissioning plan of a nuclear facility including: receiving a plurality of decommissioning related information data; determining whether error data is included in the plurality of decommissioning related information data based on a database which contains characteristic information and decommissioning plan information of a plurality of nuclear facilities; analyzing a state of a decommissioning target facility to be decommissioned by identifying the decommissioning target facility based on the plurality of decommissioning related information data and the database, wherein said analyzing the state of the decommissioning target facility is performed by identifying the decommissioning target facility based on remaining data except the error data and the database when the error data is included in the plurality of decommissioning related information data; and designing decommissioning of the decommissioning target facility based on the analysis.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A method for decommissioning plan of nuclear facility, comprising:
receiving a plurality of decommissioning related information data;
determining whether error data is included in the plurality of decommissioning related information data based on a database which contains characteristic information and decommissioning plan information of a plurality of nuclear facilities;
analyzing a state of a decommissioning target facility by identifying the decommissioning target facility based on the plurality of decommissioning related information data and the database, wherein when the error data is included in the plurality of decommissioning related information data, said analyzing is performed by identifying the decommissioning target facility based on the plurality of decommissioning related information data from which the error data is excluded and the database; and
designing a decommissioning plan of the decommissioning target facility based on the analyzed state.

2. The method of claim 1, wherein the plurality of decommissioning related information data includes information on a structure or equipment included in the decommissioning target facility.

3. The method of claim 2, wherein the information on the structure or the equipment includes at least one of information on a history of design, construction and heat output of the nuclear facility, information on a weight, a size, an installation location, and used materials, information on a design change of the nuclear facility, and information on a history of an accident, a cause of the accident, and an action for the accident in the nuclear facility.

4. The method of claim 2, wherein said determining whether error data is included in the plurality of decommissioning related information data comprises:
determining that the error date is included when there is data that is not linked to a linking structure which defines a connection relationship between the received data based on the characteristic information of the plurality of nuclear power facilities.

5. The method of claim 4, wherein the characteristic information of the plurality of nuclear power facilities includes information on an available structure and an available equipment and a relevance between the available structure and the available equipment depending on a type of each of the plurality of nuclear facility types.

6. The method of claim 1, wherein the decommissioning plan information includes decommissioning technique information for each type of the plurality of nuclear facilities and information on laws and regulations for a nuclear facility.

7. The method of claim 6, wherein the decommissioning technique information includes at least one of radiation measurement technique, decontamination technique, cutting technique, waste treatment techniques, and site restoration technique.

8. The method of claim 1, wherein said analyzing the state of the decommissioning target facility comprises:
analyzing one of decommissioning site and environmental status of the decommissioning target facility, decommissioning work activity, comparison of the applicable decommissioning technique, radioactive waste management, environmental impact during decommissioning, safety of decommissioning, radiation protection, fire protection, and decommissioning cost based on the remaining data and the database; and
determining a decommissioning technique to be used for decommissioning the decommissioning target facility to meet a predetermined criterion,
wherein the predetermined criterion is designated in accordance with the laws and regulations for the nuclear facility.

9. The method of claim 8, wherein said designing the decommissioning plan comprises:
representing the analyzed state and the determined decommissioning technique in a hierarchical structure based on the database, the type of the decommissioning target facility, and the information on the structure and equipment of the decommissioning target facility; and
outputting the analyzed state and the determined decommissioning technique represented in the hierarchical structure.

10. An apparatus for decommissioning plan of nuclear facility, comprising:
a data receiver for receiving a plurality of decommissioning related information data;
a discriminating unit for determining whether error data is included in the plurality of decommissioning related information data based on a database which contains characteristic information and decommissioning plan information of a plurality of nuclear facilities;
an analyzing unit for analyzing a state of a decommissioning target facility by identifying the decommissioning target facility based on the plurality of decommissioning related information data and the database, wherein when the error data is included in the plurality of decommissioning related information data, the analyzing unit analyzes the state of the decommissioning target facility by determining the decommissioning target facility based on the plurality of decommissioning related information data from which the error data is excluded and the database; and
a designing unit for designing a decommissioning plan of the decommissioning target facility based on the analyzed state.

11. A computer-readable recording medium having a computer program stored therein for causing a processor to perform a method for decommissioning plan of nuclear facility, the method comprising:
receiving a plurality of decommissioning related information data;
determining whether error data is included in the plurality of decommissioning related information data based on a database which contains characteristic information and decommissioning plan information of a plurality of nuclear facilities;
analyzing a state of a decommissioning target facility by identifying the decommissioning target facility based on the plurality of decommissioning related information data and the database, wherein when the error data is included in the plurality of decommissioning related information data, said analyzing is performed by identifying the decommissioning target facility based on the plurality of decommissioning related information data from which the error data is excluded and the database; and
designing a decommissioning plan of the decommissioning target facility based on the analyzed state.
